(19) United States
(12) Patent Application Publication
(10) Pub. No.: US 2008/0085133 A1
(43) Pub. Date: Apr. 10, 2008

(54) IMAGE FORMING APPARATUS, IMAGE FORMING SYSTEM, AND COMPUTER READABLE MEDIUM

(75) Inventor: Hiroshi Ishii, Tokyo (JP)

Correspondence Address: CANTOR COLBURN, LLP, 20 Church Street, 22nd Floor, Hartford, CT, 06103, US

(73) Assignee: KONICA MINOLTA BUSINESS TECHNOLOGIES, INC., Tokyo (JP)

(21) Appl. No.: 11/858,589

(22) Filed: Sep. 20, 2007

(30) Foreign Application Priority Data
Oct. 4, 2006 (JP) 2006-273154

(51) Int. Cl. G03G 15/00

(52) U.S. Cl. 399/83

(57) ABSTRACT

Disclosed is an image forming apparatus including a connecting unit to connect with other image forming apparatuses via a communication line, an image forming unit to carry out an image forming in compliance with setting information regarding the image forming according to types of a recording medium, a first storage unit to store distribution information including at least information of the image forming apparatus of a data receiver, an input unit to input the setting information regarding the image forming, a second storage unit to store the setting information input by the input unit, and a control unit to control the image forming apparatus so as to distribute the stored setting information to the other image forming apparatuses based on the distribution information stored in the first storage unit when the setting information is stored in the second storage unit.

### BACKGROUND

1. Field of the Invention

The present invention relates to an image forming apparatus, an image forming system and a computer readable medium.

2. Description of the Related Art

Conventionally, there are image forming apparatuses which form an image on the recording medium such as paper, which are a copier, a printer, and a facsimile, or a MFP (Multi Function Periphery) in which the functions of the copier, the printer and the facsimile are combined. The above described image forming apparatus is communicatably connected with an external informational device via a communication network or the like, and the image forming apparatus constitutes a part of an image forming system which carries out the printing based on the print instruction given by the informational device such as a PC (Personal Computer).

In such an image forming system, when the setting for carrying out a printing on a new type of paper or the like from the image forming apparatus is updated, the updating was carried out by executing the utility software for setting in the above-mentioned PC or the like and by transmitting the setting information regarding the paper type from the PC to the image forming apparatus in which the setting is to be changed. For example, JP2002-29120A discloses an image forming system in which the setting information regarding the attribution of the paper type to be set is transmitted to the printer from the host computer and is stored in the non-volatile memory in the printer side.

The above described related art assumes a situation in which the setting of the paper type is carried out from the PC or the like to a single image forming apparatus. When the setting of the paper type is carried out to a plurality of image forming apparatuses, it is inconvenient because the setting of the paper needs to be set individually for each image forming apparatus. Further, when the same setting is carried out to a plurality of image forming apparatuses, a setting mistake may occur in any one of the image forming apparatuses because the setting information needs to be input for each image forming apparatus.

### SUMMARY

In view of the above described problems, an object of the present invention is to reduce the labor of setting the paper type in a plurality of image forming apparatuses.

To achieve at least one of the above objects, an image forming apparatus reflecting one aspect of the present invention comprises a connecting unit to connect with other image forming apparatuses via a communication line, an image forming unit to carry out an image forming in compliance with setting information regarding the image forming according to types of a recording medium, a first storage unit to store distribution information including at least information of the image forming apparatus of a data receiver, an input unit to input the setting information regarding the image forming, a second storage unit to store the setting information input by the input unit, and a control unit to control the image forming apparatus so as to distribute the stored setting information to the other image forming apparatuses based on the distribution information stored in the first storage unit when the setting information is stored in the second storage unit.

Preferably, the image forming apparatus further comprises a registration unit to register the information of the image forming apparatus of the data receiver in the first storage unit as the distribution information, and the control unit controls the image forming apparatus so as to distribute the stored setting information to the image forming apparatus of the data receiver which is registered by the registration unit.

Preferably, the image forming apparatus further comprises a detection unit to detect a distribution error of the setting information to the image forming apparatus, and the control unit makes the distribution information store information based on the detected distribution error when the distribution error is detected by the detection unit.

Preferably, the image forming apparatus further comprises a counter memory to store a distribution frequency of the setting information to the image forming apparatus, and the detection unit detects the distribution error based on the distribution frequency stored in the counter memory.

Preferably, in the image forming apparatus, when the distributed setting information is insufficient in a setting item of the image forming apparatus of the data receiver, the control unit controls the image forming apparatus so as to set and distribute an initial value which is store in advance to the insufficient setting item.

### BRIEF DESCRIPTION OF THE DRAWINGS

The present invention will become more fully understood from the detailed description given hereinbelow and the appended drawings, and thus are not intended as a definition of the limits of the present invention, and wherein;

FIG. 1 is a schematic diagram showing an example of a structure of an image forming system;

FIG. 2 is a block diagram schematically showing a functional structure of an image forming apparatus;

FIG. 3A is a schematic diagram showing an example of contents of a distribution table;

FIG. 3B is a schematic diagram showing an example of contents of a paper table;

FIG. 3C is a schematic diagram showing an example of content of the tray registration table;

FIG. 4 is a ladder chart showing an example of a process in the image forming system;

FIG. 5 is a flow chart showing an example of a paper condition registration process;

FIG. 6 is a flow chart showing an example of a data distribution process;

FIG. 7 is a flow chart showing an example of a distributed data registration process;

FIG. 8 is a flow chart showing an example of a distribution table correction process;

FIG. 9 is a ladder chart showing a modification example of a process in the image forming system;

FIG. 10 is a schematic diagram showing an example of a structure of the image forming system;

FIG. 11 is a block diagram schematically showing a functional structure of a server PC; and

FIG. 12 is a ladder chart showing an example of a process carried out in the server PC and each image forming apparatus of the image forming system.

### DETAILED DESCRIPTION OF PREFERRED EMBODIMENTS

Hereinafter, the preferred embodiments of the present invention will be described with reference to the drawings. However, the present invention is not limited to the following embodiments. Further, the embodiments of the present invention show the best mode of the present invention, and the usage and the terminologies of the present invention are not limited to them.

### First Embodiment

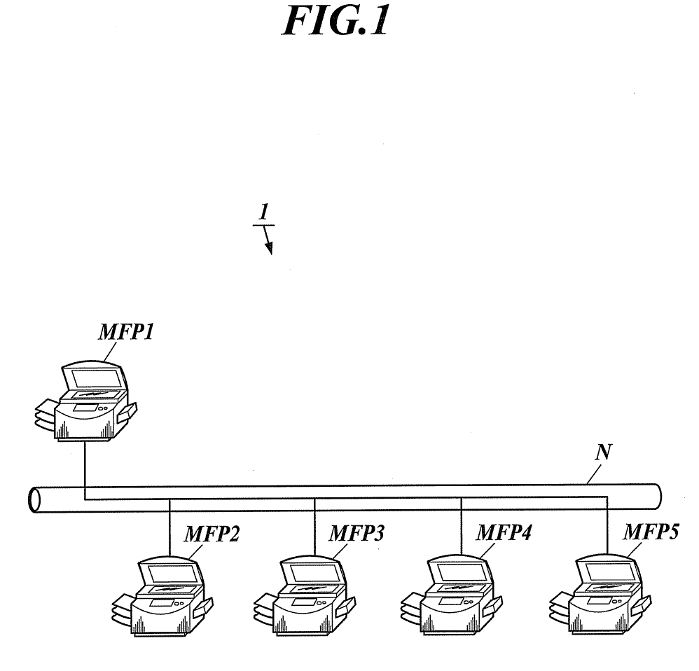

First, the first embodiment will be described with reference to FIGS. 1 to 9.

As shown in FIG. 1, the embodiment shows an example in which the present invention is applied to the image forming system 1 constituting a plurality of image forming apparatuses MFP1, MFP2, MFP3, MFP4, and MFP5 which are connected so that the data communication can be carried out via the network N. In FIG. 1, the image forming apparatuses MFP1, MFP2, MFP3, MFP4, and MFP5 are, for example, a multi-functional copier which comprises an image forming function to carry out printing by the electrophotography process, a scanning function to read the document and to obtain the image data, a communication function to carry out sending and receiving of the image data via the network I/F (interface) and the like. The image forming apparatuses MFP1, MFP2, MFP3, MFP4, and MFP5 may be connected with an informational device such as a PC or the like (omitted from the drawing) via the USB cable or the like, and may comprise the after-mentioned control system of the image forming apparatus in the PC side. In the embodiment, the structure comprising the control system in the image forming apparatus side is applied.

For example, the LAN (Local Area Network) or the like is the network N in the image forming system 1. However, the structure of the network N is not limited to the LAN as long as the network N means a communication path capable of sending and receiving the data. For example, the network N may be a communication using the internet or the like.

Hereinbelow, the functional structure of the image forming apparatuses MFP1, MFP2, MFP3, MFP4, and MFP5 will be described in detail. The above mentioned functional structure of each image forming apparatus is approximately the same except for the processing rate and the like. Therefore, the image forming apparatus MFP1 will be described in the following description and the description of the image forming apparatuses MFP2, MFP3, MFP4, and MFP5 will be omitted for simplification.

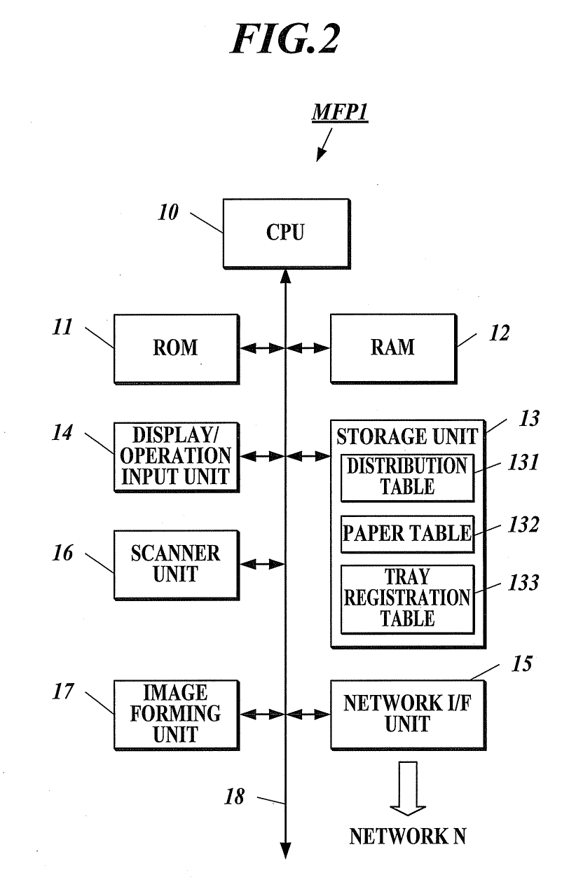

As shown in FIG. 2, the image forming apparatus MFP1 comprises a CPU 10 (Central Processing Unit), a ROM 11 (Read Only Memory), a RAM 12 (Random Access Memory), a storage unit 13, a display/operation input unit 14, a network I/F unit 15, a scanner unit 16 and an image forming unit 17, and each unit is communicatably connected to one another by a bus 18.

The CPU 10 reads the operation program stored in the ROM 11 and the storage unit 13, various types of application programs to carry out various types of processes such as the image forming, the image reading, the image conversion and the like, and the image data, expands the program data and the image data on the RAM 12 as a work area, and integratedly controls each unit of the image forming apparatus MFP1. The ROM 11 is a non-volatile memory to store the above-mentioned various types of program data and the like in advance. The RAM 12 is, for example, a DRAM (Dynamic RAM) or the like, and provides a work area when the CPU 10 orderly executes the programs.

The storage unit 13 is a magnetic or an optic storage medium, a non-volatile memory such as a semiconductor or the like (for example, a HDD (Hard Disk Drive) or the like) or the like, and the storage unit 13 can read and write the data from the CPU 10. Further, the storage unit 13 stores a distribution table 131, a paper table 132, and a tray registration table 133.

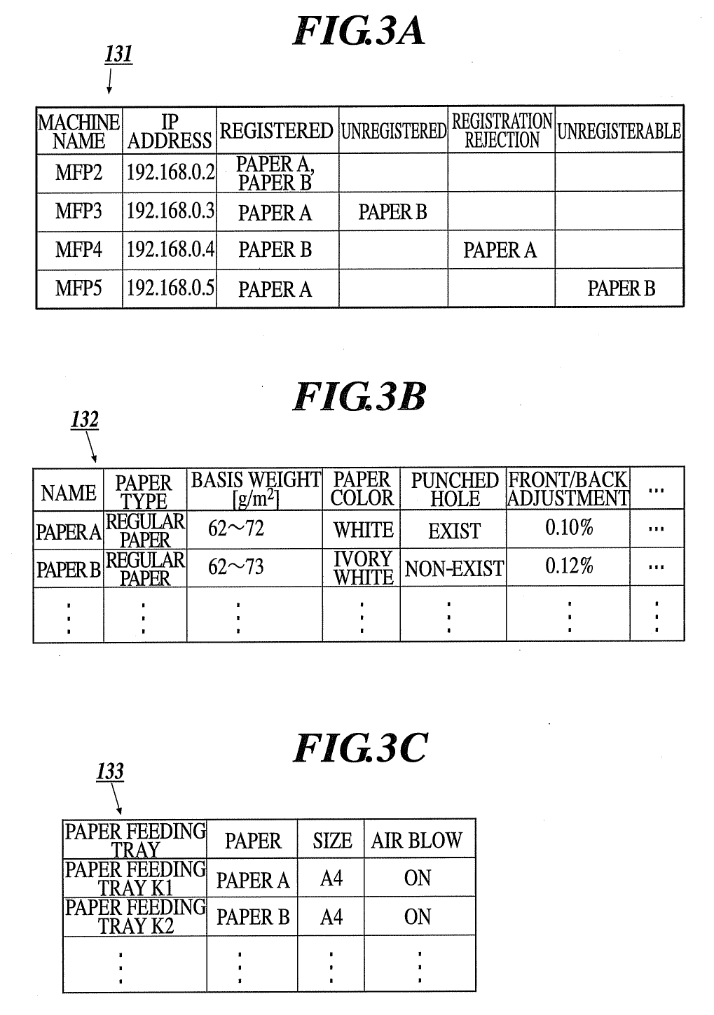

The distribution table 131 is a data table which stores data relating to the data distribution to the other image forming apparatuses and data relating to the registration situation of various types of setting information according to the data distribution for each of the other image forming apparatuses. Specifically, as shown in FIG. 3A, the distribution table 131 is a data table which stores information such as an “IP address” (for example, “192. 168. 0. 2” or the like) which is an address of the particular image forming apparatus on the network N, a “Registered” (for example, “paper A, paper B” or the like) which indicates the setting information of the paper type which is registered in the particular image forming apparatus, an “unregistered” (for example, “paper B” or the like) which indicates the setting information of the paper type which is unregistered in the image forming apparatus, a “registration rejection” (for example, “paper A” or the like) which indicates the setting information of the paper type in which the registration is rejected in the image forming apparatus, an “unregisterable” (for example, “paper B” or the like) which indicates the setting information of the paper type which cannot be registered in the image forming apparatus or the like for each “machine name” (for example, “MFP2” or the like) which is the name of other image forming apparatuses.

The paper table 132 is a data table which stores the setting condition regarding the image forming for each type of the storing medium such as paper or the like. Specifically, as shown in FIG. 3B, the paper table 132 is a data table which stores information such as a “name” (for example, “paper A” or the like) which indicates the name for each setting, a “paper type” (for example, “regular paper” or the like) which indicates the type of the paper on which the image forming is carried out, a “basis weight” (for example, “62 to 72” or the like) which indicates the basis weight of the paper on which the image forming is carried out, a “paper color” (for example, “white” or the like) which indicates the color of the paper on which the image forming is carried out, a “punched hole” (for example, “exists” or the like) which indicates whether the paper on which the image forming is carried out has a punched hole or not, a “front/back adjustment” (for example, “0.10” or the like) which indicates the amount of fine adjustment (minute magnification of front surface and back surface) when both sides of the paper on which the image forming is carried out are printed or the like.

The tray registration table 133 is a data table which stores the setting condition regarding the image forming carried out for each paper feeding tray (omitted from the drawing) which stores the recording medium in the image forming unit 17. Specifically, as shown in FIG. 3C, the tray registration table 133 is a data table which stores the information such as a “paper” (for example, “paper A” or the like) which indicates the setting name in the paper table 132 or the like for each “paper feeding tray” (for example, “paper feeding tray K1” or the like) in the image forming unit 17.

The display/operation input unit 14 comprises a display monitor which is composed of a TFT (Thin Film Transistor) element or the like and a pressure sensitive type (resistive type) transparent touch panel in which clear electrodes are arranged in lattice on the screen of the display monitor. The display/operation input unit 14 comprises a function of displaying the various types of processes and the guiding information for a user in the image forming apparatus MFP1 under the control of the CPU 10, and a function as an input device which outputs the operation signal based on the operational instruction input by a user to the CPU 10 under the control of the CPU 10.

The network I/F unit 15 is an interface connected with the above-mentioned network N. Further, the network I/F unit 15 is a functional unit which carries out the data communication with the external device which is connected with the network N according to a predetermined communication protocol under the control of the CPU 10.

The scanner unit 16 emits a light to the to-be-read document (omitted from the drawing), captures the light reflected from the to-be-read document by the CCD (Charge Coupled Device) image sensor, the CMOS (Complementary Metal-Oxide Semiconductor) image sensor or the like, converts the analog electrical signal output based on the captured light into a multilevel digital signal by an A/D converter (omitted from the drawing), and outputs the converted multilevel digital signal to the CPU 10. In the image forming apparatus MFP1, the image data regarding the to-be-read document based on the multilevel digital signal which is output from the scanner unit 16 is stored in the storage unit 13 or the like and the image conversion into a predetermined data format and the image forming are carried out under the control of the CPU 10.

The image forming unit 17 is a printer which forms the image on the recording medium such as paper by known various types of systems such as an inkjet printing system a laser printing system, a thermal transfer printing system, a dot impact printing system or the like. The laser printing system is applied in the embodiment, and the image can be formed on the recording medium by the electrophotography process based on the image data obtained by the scanner unit 16 and the image data input via the network I/F unit 15.

The image forming unit 17 comprises paper feeding trays (omitted from the drawing), and carries out image forming in compliance with the paper type condition which is set for each paper feeding tray based on the setting of the paper table 132 and the tray registration table 133 stored in the storage unit 13 under the control of the CPU 10. That is, the image forming apparatus MFP1 can carry out the image forming according to the paper type by obtaining the setting name which corresponds to the paper feeding tray based on the information stored in the tray registration table 133 and by carrying out the image forming in compliance with the setting condition obtained by the tray registration table 133 on the basis of the obtained setting name when the image is formed on the paper stored in any one of the paper feeding tray.

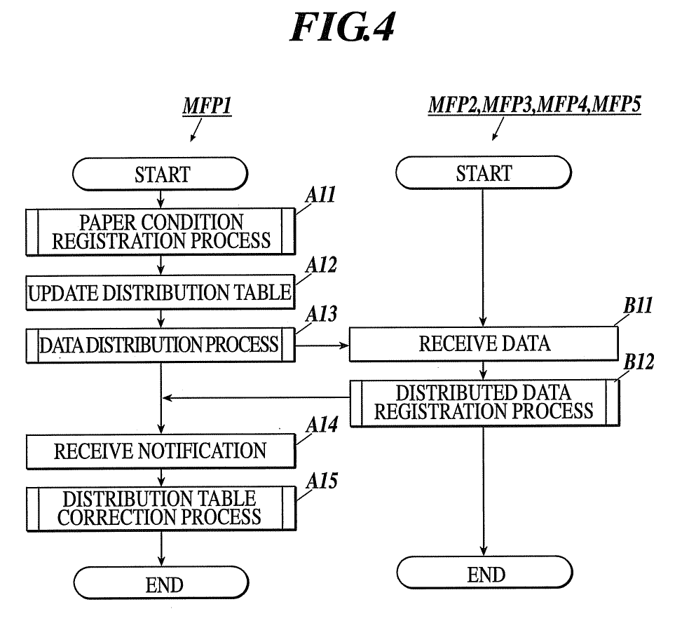

Next, the process regarding the registration of the paper type to the image forming apparatus MFP1 and the distribution of the registered contents to the other image forming apparatuses which are the processes carried out in the image forming apparatus MFP1 and the image forming apparatus MFP2, MFP3, MFP4, and MFP5 in the image forming system 1 will be described in detail with reference to FIG. 4. Here, steps A11 to A15 in FIG. 4 are the processes carried out by the CPU 10 of the image forming apparatus MFP1, and steps B11 to B12 are the processes carried out by each CPU of the image forming apparatuses MFP2, MFP3, MFP4, and MFP5.

As shown in FIG. 4, the image forming apparatus MFP1 accepts the operational instruction from the display/operation input unit 14 or the like and carries out the paper condition registration process to register the image forming condition for each paper type (step A11). Then, the image forming apparatus MFP1 updates the contents stored in the distribution table 131 by assuming that the registered paper condition is undistributed to other image forming apparatuses, (step A12), and carries out the data distribution process to distribute the setting information regarding the image forming conditions for each paper type which is registered in step A11 to other image forming apparatuses based on the updated distribution table 131 (step A13).

The image forming apparatuses MFP2, MFP3, MFP3, MFP4, and MFP5 which are the other image forming apparatuses with respect to the image forming apparatus MFP1 receive the setting information regarding the image forming condition for each paper type which is distributed from the image forming apparatus MFP1 (step B11), carry out the distribution data registration process to register the image forming condition for each paper type regarding the particular machine based on the received setting information (stet B12), and the process is finished.

Next, the image forming apparatus MFP1 receives the information regarding whether the image forming condition is registerable or not which is notified in the distribution data registration process (step B12) in the other image forming apparatuses (step A14), carries out the correction process of the distribution table 131 based on the received notification (step A15), and the process is finished.

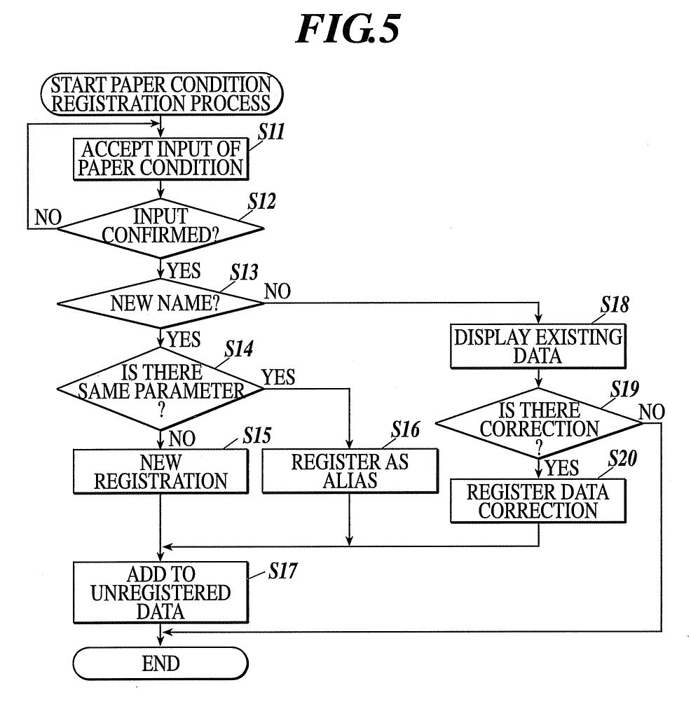

The paper condition registration process (steps A11 and A12) including the update of the distribution table 131 will be described in detail. As shown in FIG. 5, when the paper condition registration process is started, the input for setting the paper condition is accepted from the display/operation input unit 14 until the input confirmation is instructed (step S11 and S12). In this input for setting the paper condition, the information regarding the image forming condition for each paper type which is to register in the paper table 132 is accepted. Specifically, the inputting of the information such as the above-mentioned “name”, “paper type”, “basis weight”, “paper color”, “punched hole”, “front/back adjustment” and the like is accepted.

Subsequently, whether the paper condition accepted in step S11 is a new name or not is determined, that is, whether the “name” input at the time of acceptance is a new name which is not stored in the paper table 132 or not is determined (step S13). When the accepted paper condition is a new name, whether the parameters such as “paper type”, “basis weight”, “paper color”, “punched hole”, “front/back adjustment” and the like are same as the parameters of other names which are already stored in the paper table 132 or not is determined (step S14).

When it is determined that the parameters are not the same (NO) in step S14, the contents which are accepted in step S11 are newly registered in the paper table 132 (step S15). Further, when it is determined that the parameters are the same (YES) in step S14, the contents accepted in step S11 are registered as an alias in the paper table 132. In this alias registration, the contents accepted in step S11 are already registered in the paper table 132, and the memory needed to store the paper table 132 is saved by being set so as to refer to the data of the name in which the parameters are the same.

Next, the registered “name” is added to the “unregistered” in the distribution table 131 of the other image forming apparatuses so as to indicate that the registered contents are unregistered in the other image forming apparatuses (step S17), and the process is finished.

The process of step S17 is a process which corresponds to the above-mentioned step A12. That is, concerning the paper type information which is registered in the image forming apparatus MFP1, the “name” is added to the “unregistered” in the distribution table 131 regarding the image forming apparatus which distributes the paper type information in the paper condition registration process. Thereby, the image forming apparatus which is the receiver of the paper type information can be assigned in the image forming apparatus MFP1. When the “name” is added to the “unregistered” in step S17, it may be structured so that the “name” which is already set in the “unregisterable” may not be added to the “unregistered”. In such a case, the distribution to the MFP in which the information cannot be registered in advance can be avoided, that is, unneeded distributions can be avoided.

In step S13, when the “name” which is input at the time of acceptance in step S11 is already stored in the paper table 132 (NO), the existing data which is already stored in the paper table 132 by the “name” is displayed on the display/operation input unit 14, and it is confirmed whether there is a correction in the contents which are input in step S11 or not (step S18). When it is determined that there is a correction based on the correction instruction from the display/operation input unit 14 (step S19: YES), the correction of the existing data which is stored in the paper table 132 is registered and the process proceeds to step S17. In step S19, when the correction instruction is not input from the display/operation input unit 14 and when it is determined that the correction is not needed (NO), the process is finished as it is.

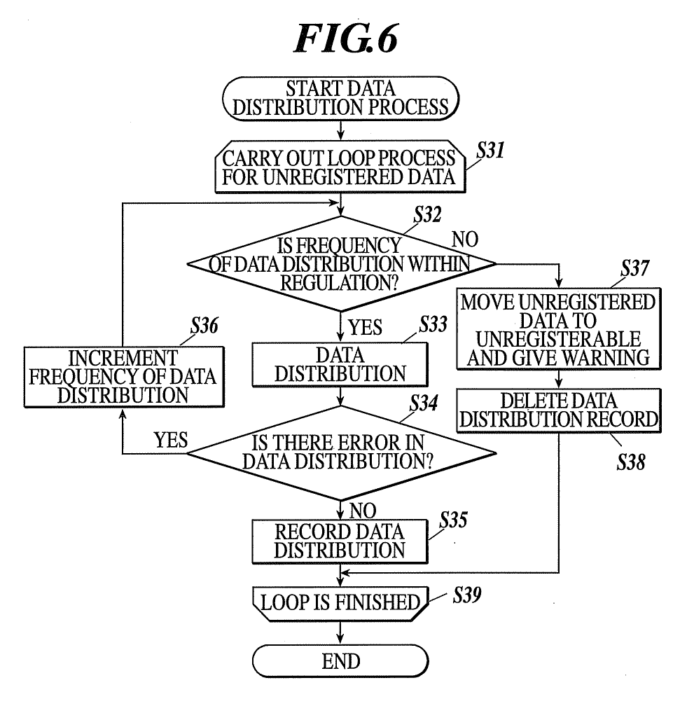

The data distribution process (step A13) will be described in detail. As shown in FIG. 6, when the data distribution process is started, the loop process to carry out the data distribution to the image forming apparatus in the “machine name” of which the “name” is set in the “unregistered” in the distribution table 131, that is, the loop process to distribute the setting information (“name”, “paper type”, “basis weight”, “paper color”, “punched hole”, “front/back adjustment” and the like) regarding the paper type according to the “name” to the image forming apparatus in which the setting information is unregistered is carried out to all of the “unregistered” (step S31 to S39).

When the loop process to distribute the setting information to any one of the image forming apparatuses in which the setting information is unregistered is started, it is determined whether the frequency of data distribution which is counted based on a counter (initial value of 0) or the like ensured in the RAN 12 or the like is within the defined value which is set in advance or not (step S32). In this determination, data distribution to the other image forming apparatuses is attempted more than the defined number of times because of a communication error or the like, therefore the case where the setting information cannot be registered by the data communication can be detected.

When it is determined that the frequency of data distribution is within the defined value (YES) in step S32, the setting information regarding the “name” set in the “unregistered” in the distribution table 131 is read from the paper table 132, and the data distribution of the setting information is carried out based on the “IP address” of the image forming apparatus in which the setting information is unregistered (step S33). Then, it is determined whether there is an error such as no-response, rejection response or the like to the data distribution or not (step S34). When it is determined that there is an error, the above mentioned counter which counts the frequency of the data distribution is incremented and the process returns to step S32, when it is determined that there is no error, it is stored that the data distribution is carried out successfully in the RAM 12 or the like (step S35), and the process proceeds to the next loop process.

Moreover, when it is determined that the data distribution frequency is not within the defined value (NO) in step S32, that is, when the setting information cannot be registered in the other image forming apparatuses because the setting information cannot be distributed, the “name” set in the “unregistered” in the distribution table 131 is moved to the “unregisterable” in the distribution table 131, a warning that the setting information is not registered in the other image forming apparatus because an error is displayed on the display/operation input unit 14 (step S37), the record to distribute the setting information, that is, the “name” set in the “unregistered” in the distribution table 131 is deleted (step S38), and the process proceeds to the next loop process.

In the above described data distribution process, the image forming apparatus MFP1 is constructed so as to record the distribution error in the distribution table 131 when it is detected that the error has occurred when the setting information is distributed to the other image forming apparatuses from the image forming apparatus MFP1.

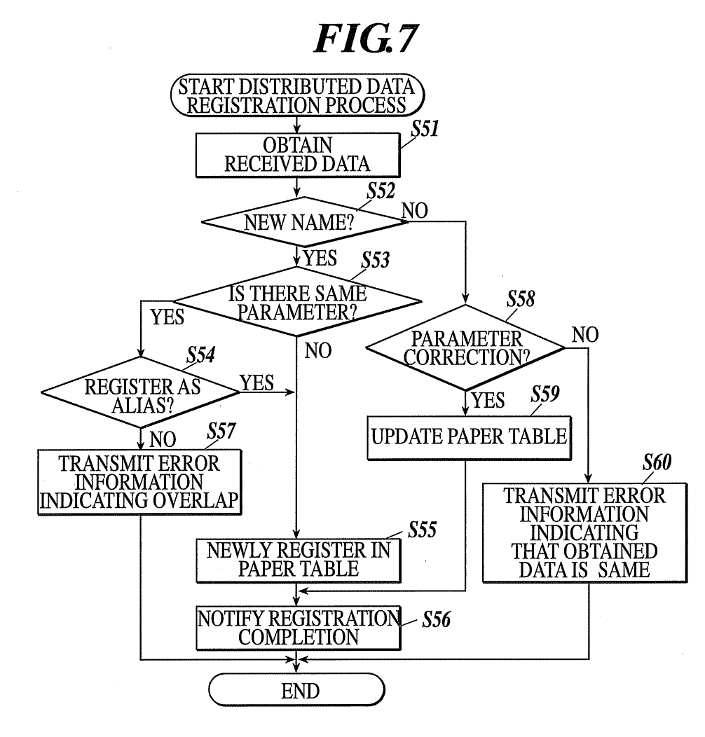

The distributed data registration process (step B12) will be described in detail. As shown in FIG. 7, when the distributed data registration process is started, the data received in step B11, that is, the setting information (“name”, “paper type”, “basis weight”, “paper color”, “punched hole”, “front/back adjustment” and the like) regarding the image forming condition for each paper type is obtained (step S51), and the paper table which is stored in the particular machine is referred from the obtained “name” and determined whether it is a new name or not (step S52).

In step S52, when it is determined that the setting information is not included in the paper table which is stored in the particular machine from the obtained “name”, and when the name is determined as a new name (YES), the received parameters such as “paper type”, “basis weight”, “paper color”, “punched hole”, “front/back adjustment” and the like are determined whether they are same as the parameters of the other names which are also stored in the paper table of the particular machine or not (step S53). When the parameters are the same (step S53: YES), the obtained parameters are determined whether they will be registered as alias or not (step S54). Here, the determination made in step S54 is based on the information set in the ROM or the like of the particular machine which is the information such as availability of alias registration in a case where the data obtained via the network N is being referred to and not the data from the display/operation input unit of the particular machine.

When the obtained parameters are not the same parameters (step S53: NO) or when the obtained parameters are registered as alias although they are the same parameters (step S54: YES), similarly to steps S15 and S16, the data received in step B11 is newly registered in the paper table of the particular machine (step S55), the notification indicating that the registration has completed will be transmitted to the sender (step S56), and the process is finished. Further, when the obtained parameters are not registered in a different name (step S54: NO), an error information indicating that it is an overlapped data with different “name” is transmitted to the sender (step S57), and the process is finished.

In step S52, when it is the “name” included in the paper table which is stored in the particular machine, and when the received setting information is already set in the paper table of the particular machine, each parameter such as “paper type”, “basis weight”, “paper color”, “punched hole”, “front/back adjustment” and the like of the received setting information is compared with the parameters which are already set in the particular machine, and whether the parameters will be corrected or not is determined by the existence or non-existence of changes (step S58). When the correction of the parameters is carried out because there are changes in the parameters (YES), the paper table which is stored in the particular machine is updated based on the received setting information (step S59), and the process proceeds to step S56. Further, when the correction of the parameters is not carried out because there are no changes in the parameters (NO), error information indicating that the received setting information is same as the setting information of the particular machine is transmitted to the sender (step S60), and the process is finished.

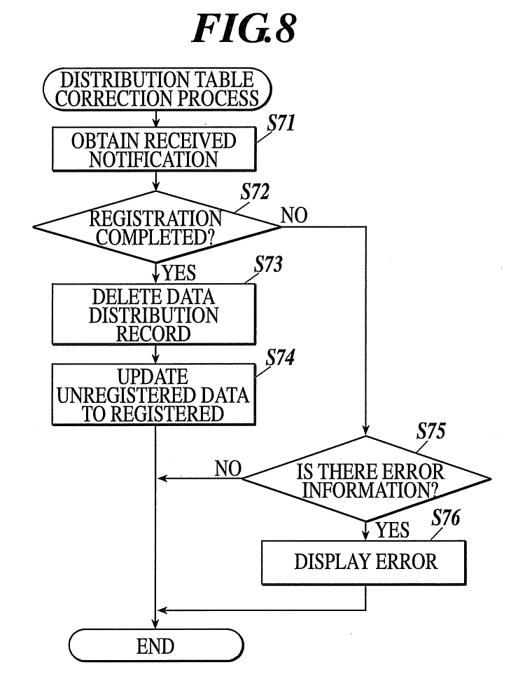

The distribution table correction process (step A15) will be described in detail. As shown in FIG. 8, when the distribution table correction process is started, a notification regarding the registerability of the image forming condition in the other image forming apparatuses which is received in step A14 is obtained (step S71), and whether the registration is completed or not is determined based on the obtained notification (step S72).

In step S72, when it is determined that the registration is completed (YES), the record to distribute the setting information to the sender of the notification, that is, the “name” regarding the sender which is set in the “unregistered” in the distribution table 131 is deleted (step S73), the “name” set in the “unregistered” is updated to “registered” (step S74), and the process is finished.

In step S72, when it is determined that the registration is not completed (NO), it is determined whether the error information from the sender is included in the notification obtained in step S71 (step S75). In the above determination, when it is determined that the error information is included in the notification, the error information is displayed on the display/operation input unit 14 (step S76), and the process is finished. Here, in step S76, the “name” set in the “unregistered” of the distribution table 131 is deleted based on the notified error information, and the “name” is updated in the “registration rejection”.

In the above described embodiment, when the setting regarding the paper type is carried out in the image forming apparatus MFP1, the set information regarding the paper type is distributed based on the distribution table 131 to the image forming apparatuses MFP2, MFP3, MFP4, and MFP5 which are communicatably connected via the network N. Therefore, the setting regarding the paper type can be carried out for the image forming apparatuses MFP2, MFP3, MFP4, and MFP5 by only carrying out the setting regarding the paper type for the image forming apparatus MFP1. Thus, the labor of setting the paper type can be reduced. Here, the setting of the paper type can be carried out in the image forming apparatus other than the image forming apparatus MFP1, and it is not particularly limited to the above described embodiment.

### Modification Example

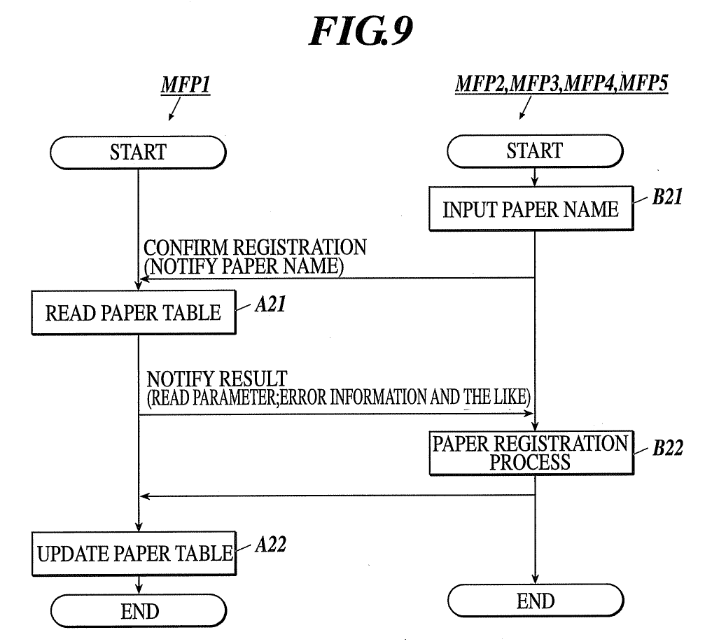

Next, a system in which the paper table 132 of the image forming apparatus MFP1 which serves as a server is referred to and used by other image forming apparatuses, which is a process in which the setting information for each paper type is registered in the image forming apparatuses of the entire image forming system by registering the setting information for each paper type to the image forming apparatus MFP1 will be described in detail with reference to FIG. 9 as a modification example of the image forming system 1. Here, steps A21 and A22 in FIG. 9 are the processes which the CPU 10 of the image forming apparatus MFP1 carries out, and steps B21 and B22 are the processes which each CPU of the image forming apparatuses MFP2, MFP3, MFP4, and MFP5 carry out.

As shown in FIG. 9, the image forming apparatuses MFP2, MFP3, MFP4, and MFP5 accept the input of the name for carrying out the setting for each paper type from the display/operation input unit or the like (step B21), and inquire whether the image forming condition regarding the name (paper type) is registered in the image forming apparatus MFP1 or not by notifying the name to the image forming apparatus MFP1.

subsequently, the image forming apparatus MFP1 reads the paper table 132 based on the name which is notified from the image forming apparatuses MFP2, MFP3, MFP4, and MFP5 (step A21), and notifies the result of the reading to the image forming apparatuses MFP2, MFP3, MFP4, and MFP5.

In the reading of the paper table 132, when there is a data which is the same as the notified name, the setting parameters (“paper type”, “basis weight”, “paper color”, “punched hole”, “front/back adjustment” and the like) are read, and the read parameters are notified to the other image forming apparatuses. When the same data does not exist, error information or the like indicating that the setting parameters regarding the notified name does not exist is notified to the other image forming apparatuses.

Next, the image forming apparatuses MFP2, MFP3, MFP4, and MFP5 display the parameters notified from the image forming apparatus MFP1 on the screen and accepts the operational instruction such as changes in parameters or the like in the display/operation input unit 14. Alternatively, when the notification from the image forming apparatus MFP1 is error information, the image forming apparatuses MFP2, MFP3, MFP4, and MFP5 carry out the registration process regarding the paper (paper type) of the name which is input in step B21 (step B22), and notify the information of parameters or the like after the registration processing to the image forming apparatus MFP1.

Then, the image forming apparatus MFP1 updates the paper table 132 based on the parameters after the registration processing which are notified from the image forming apparatuses MFP2, MFP3, MFP4, and MFP5 (step A22).

In the above described modification example, the settings of the paper type which are carried out in the image forming apparatus MFP2, MFP3, MFP4, and MFP5 are notified to the image forming apparatus MFP1 which serves as a server that administrates various types of setting information and register the settings of paper type in the image forming apparatus MFP1. In such a case, the registration of the paper type can be carried out to the image forming apparatuses which are communicatably connected to the image forming apparatus MFP1 by only registering the setting of the paper type carried out in any one of the image forming apparatuses to the image forming apparatus MFP1, and the labor of setting the paper type can be reduced.

### Second Embodiment

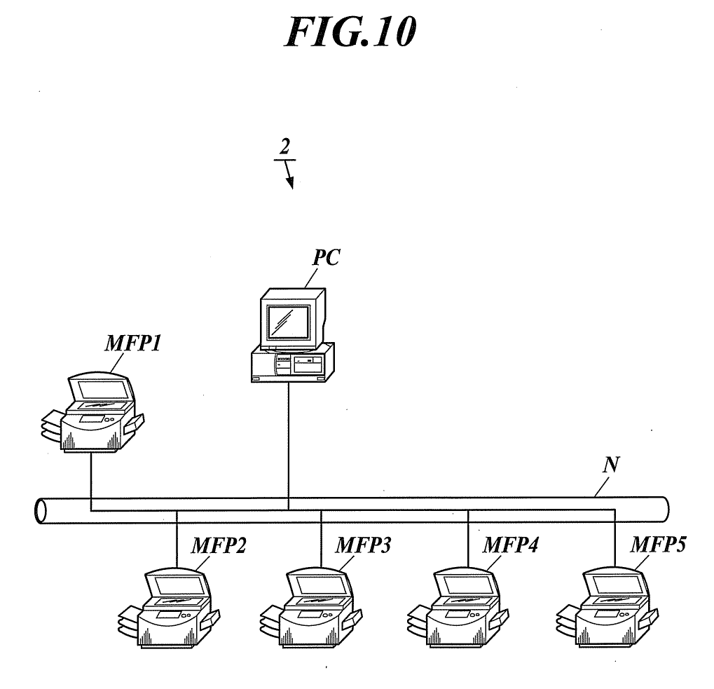

Next, the second embodiment will be described with reference to FIGS. 10 to 12. In the description hereinbelow, the same reference numerals are used and the descriptions are omitted for the structures which are the same as the above described embodiments.

In the embodiment, as shown in FIG. 10, an example in which the present invention is applied to the image forming system 2 constituting a plurality of image forming apparatuses MFP1, MFP2, MFP3, MFP4, and MFP5 and a server PC which are connected so as to carry out the data communication is shown. In FIG. 10, the server PC is an informational device such as a WS (Work Station) or so-called PC, and the server PC gives a printing instruction to each MPF and administrates the setting information of each MFP.

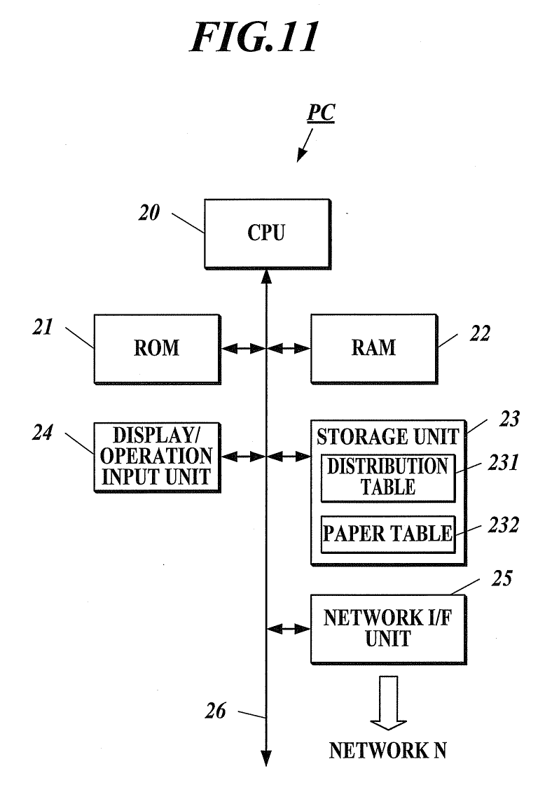

As shown in FIG. 11, the server PC comprises a CPU 20, a ROM 21, a RAM 22, a storage unit 23, a display/operation input unit 24, and a network I/F unit 25, and each part is communicatably connected by a bus 26 to one another.

The CPU 20 reads an operation program, various types of application program and various types of setting information which are stored in the ROM 21 and the storage unit 23, expands the program data and various types of setting information on the RAM 22 as a work area, and integratedly controls each unit of the server PC. The ROM 21 is a non-volatile memory which stores the above described various types of program data and the like in advance. The RAM 22 is, for example, a DRAM or the like, and provides a work area when the CPU 20 orderly executes the program.

The storage unit 23 is a magnetic or an optic storage medium, a non-volatile memory or the like such as a semiconductor (for example, a HDD (Hard Disk Drive) or the like) or the like, and the storage unit 23 can read and write the data from the CPU 20. Further, the storage unit 23 stores the distribution table 231 and the paper table 232 which are the same data as the above described distribution table 131 and the paper table 132.

The display/operation input unit 24 is a display device such as a display monitor or the like such as the CRT (Cathode Ray Tube), the liquid crystal, the plasma or the like and an input device such as a mouse, a key board or the like, and displays the image based on the instruction from the CPU 20 or outputs the operational signal based on the operational instruction which is input by a user to the CPU 20.

The network I/F unit 25 is an interface which connects with the network N, and is a functional unit which carries out the data communication between the outer device connected with the network N according to the predetermined protocol under the control of the CPU 20.

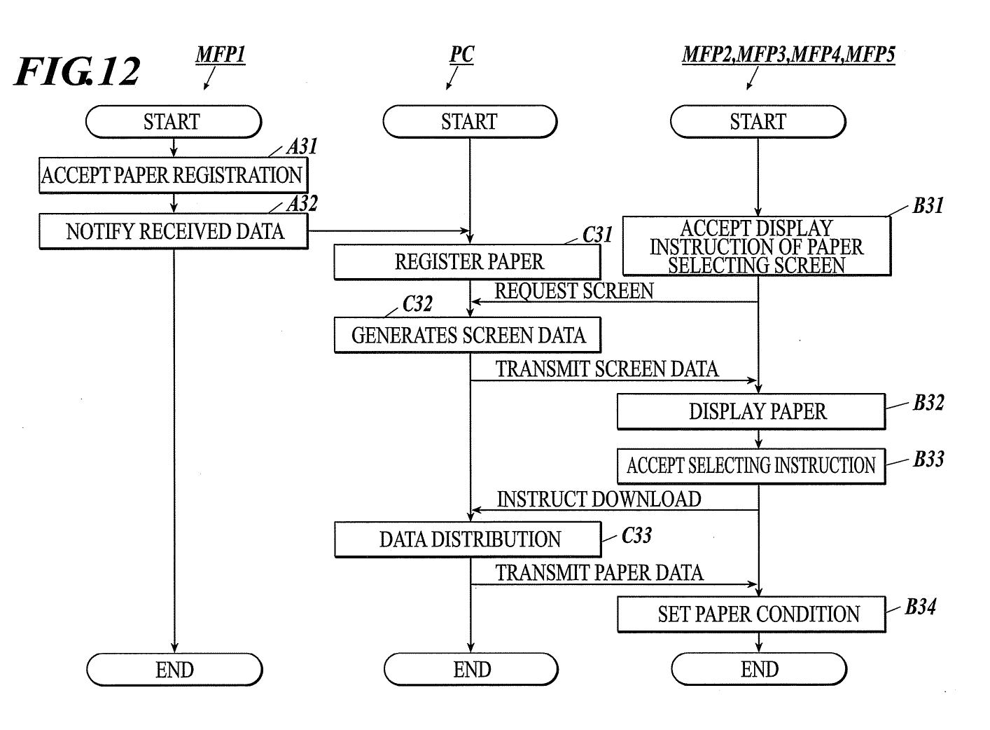

Next, the registration process of the paper type which is accepted in the image forming apparatus MFP1 to the server PC and the process of setting the paper type in the image forming apparatuses MFP2, MFP3, MFP4, and MFP5 by downloading the setting from the server PC which are the processes carried out in the server PC, the image forming apparatus MFP1 and the image forming apparatus MFP2, MFP3, MFP4, and MFP5 in the image forming system 2 will be described in detail with reference to FIG. 12.

Here, steps A31 and A32 in FIG. 12 are the processes carried out by the CPU 10 of the image forming apparatus MFP1, steps B31 to B34 are the processes carried out by the CPUs in the image forming apparatuses MFP2, MFP3, MFP4, and MFP5, and steps C31 to C33 are the processes carried out by the CPU 20 of the server PC.

In the embodiment, the structure in which the registration regarding the paper type to the server PC is carried out in the image forming apparatus MFP1, and the structure in which the setting of the paper type is downloaded by the image forming apparatus MFP2, MFP3, MFP4, and MFP5 is described. However, the registration and the downloading of the setting can be carried out in any one of the image forming apparatuses and it is not particularly limited.

First, the registration process of the paper type which is accepted by the image forming apparatus MFP1 to the server PC will be described. As shown in FIG. 12, the image forming apparatus MFP1 accepts the setting (“name”, “paper type”, “basis weight”, “paper color”, “punched hole”, “front/back adjustment” and the like) for each paper type from the display/operation input unit 14 or the like (step A31), and notifies the accepted data to the server PC (step A32). In the server PC, the paper is registered to the paper table 232 which is stored in the particular machine based on the data notified from the image forming apparatus MFP1 (step C31).

Next, the process in which the setting of the paper type in the image forming apparatuses MFP2, MFP3, MFP4, and MFP5 are carried out by downloading the setting from the server PC will be described. Here, such a process is a process in which the setting of the paper type in the image forming apparatus is carried out by downloading the setting from the server PC, and the setting of the paper type in the image forming apparatus MFP1 may also be carried out by downloading the setting from the server PC.

As shown in FIG. 12, the image forming apparatuses MFP2, MFP3, MFP4, and MFP5 accept the screen display instruction for selecting the paper (paper type) which is set as the image forming condition for every paper feeding tray in the display/operation input unit 14 or the like (step B31), and transmits the screen request to the server PC.

Then, the server PC reads the paper table 232 according to the screen request from the image forming apparatuses MFP2, MFP3, MFP4, and MFP5, generates the screen data to select the paper type which is stored in the paper table 232 (step C32), and returns the screen data.

Subsequently, the image forming apparatus MFP2, MFP3, MFP4, and MFP5 display the screen to select the paper based on the screen data for selecting the paper type which is transmitted from the server PC in the display/operation input unit 14 and accept the selection instruction (step B32, B33), and then notifies the download instruction of the parameters regarding the selected paper to the server PC.

The server PC reads the parameters regarding the paper in which the download instruction is given by the image forming apparatuses MFP2, MFP3, MFP4, and MFP5 from the paper table 232, and distributes the parameters as paper data to the image forming apparatus in which the download instruction is given (step C33). The image forming apparatuses MFP2, MFP3, MFP4, and MFP5 carry out the setting for each paper feeding tray according to the paper condition (image forming condition) which is selected in step B31 based on the paper data distributed from the server PC (step B34).

In the above described embodiment, for example, the setting of the paper type which is accepted in the image forming apparatus MFP1 or the like is registered in the server PC, and the paper type setting which is registered in the server PC is downloaded in the image forming apparatuses MFP2, MFP3, MFP4, and MFP5. Therefore, in the image forming system 2, the labor of setting the paper type can be reduced, and the setting of the paper type carried out in any of the image forming apparatuses can be uniformly controlled by the server PC.

As described above, when the setting regarding the paper type is carried out in the display/operation input unit 14 and is stored in the paper table 132 of the particular machine, the image forming apparatus MFP1 distributes the setting information to the other image forming apparatuses which are communicatably connected via the network N based on the distribution table 131. Therefore, the labor of setting the paper type to the other image forming apparatuses can be reduced.

Moreover, the image forming apparatus MFP1 carries out steps A11 and A12, registers the image forming apparatus which distributes the information regarding the setting of the paper type which is registered in the particular machine in the distribution table 131, and distributes the setting of the paper type based on the distribution table 131. Therefore, the receiver of the setting of the paper type can be selected.

The image forming apparatus MFP1 carries out the data distribution process of step A13, detects that the error has occurred when the setting information is distributed to the other image forming apparatuses, and can record the distribution error in the distribution table 131.

Further, by counting the frequency of distribution of the setting information by the counter in the RAM 12, the image forming apparatus MFP1 can detect the distribution error based on the frequency of the distribution which is counted.

In the image forming system 2, the paper type information registered in the image forming apparatus MFP1 is administered in the server PC, and the setting of the paper type which is administered in the server PC is downloaded in the image forming apparatuses MFP2, MFP3, MFP4, and MFP5. Therefore, in the image forming system 2, the labor of setting the paper type is reduced and the setting of the paper type which is carried out in any of the image forming apparatuses can be uniformly controlled by the server PC.

The above described embodiments are examples, and they are in no way limitative. The structures and the operations in the above described embodiments can be appropriately changed within the scope of the invention.

For example, the setting items of the paper type are assumed to be the same in the above described image forming apparatuses MFP1 to MFP5. However, there may be items which cannot be set according to the functional limits such as the paper size or the like which can be handled by the image forming apparatus. In such a case, when there are more items in the image forming apparatus which registers the items than the image forming apparatus in which the items are registered by the data distribution, the values of the extra items will not be referred to in the image forming apparatus which registers the items. Contrary, when there are more items in the image forming apparatus in which the items are registered by the data distribution than the image forming apparatus which registers the items, the initial values set in the ROM or the like in advance are set in the image forming apparatus in which the items are registered.

According to a first aspect of the preferred embodiments of the present invention, there is provided an image forming apparatus comprising a connecting unit to connect with other image forming apparatuses via a communication line, an image forming unit to carry out an image forming in compliance with setting information regarding the image forming according to types of a recording medium, a first storage unit to store distribution information including at least information of the image forming apparatus of a data receiver, an input unit to input the setting information regarding the image forming, a second storage unit to store the setting information input by the input unit, and a control unit to control the image forming apparatus so as to distribute the stored setting information to the other image forming apparatuses based on the distribution information stored in the first storage unit when the setting information is stored in the second storage unit.

In the above described image forming apparatus (image forming system, medium), labor of setting the paper type in the plurality of image forming apparatuses can be reduced.

Preferably, the image forming apparatus (the image forming system) further comprises a registration unit to register the information of the image forming apparatus of the data receiver in the first storage unit as the distribution information, and the control unit controls the image forming apparatus so as to distribute the stored setting information to the image forming apparatus of the data receiver which is registered by the registration unit.

Preferably, the image forming apparatus (the image forming system) further comprises a detection unit to detect a distribution error of the setting information to the image forming apparatus, and the control unit makes the distribution information store information based on the detected distribution error when the distribution error is detected by the detection unit.

Preferably, the image forming apparatus (the image forming system) further comprises a counter memory to store a distribution frequency of the setting information to the image forming apparatus, and the detection unit detects the distribution error based on the distribution frequency stored in the counter memory.

Preferably, in the image forming apparatus (the image forming system), when the distributed setting information is insufficient in a setting item of the image forming apparatus of the data receiver, the control unit controls the image forming apparatus so as to set and distribute an initial value which is store in advance to the insufficient setting item.

The present U.S. patent application claims a priority under the Paris Convention of Japanese patent application No. 2006-273154 filed on Oct. 4, 2006, which shall be a basis of correction of an incorrect translation.

What is claimed is:

1. An image forming apparatus, comprising:
a connecting unit to connect with other image forming apparatuses via a communication line;
an image forming unit to carry out an image forming in compliance with setting information regarding the image forming according to types of a recording medium;
a first storage unit to store distribution information including at least information of the image forming apparatus of a data receiver;
an input unit to input the setting information regarding the image forming;
a second storage unit to store the setting information input by the input unit; and
a control unit to control the image forming apparatus so as to distribute the stored setting information to the other image forming apparatuses based on the distribution information stored in the first storage unit when the setting information is stored in the second storage unit.

2. The image forming apparatus of claim 1, further comprising:
a registration unit to register the information of the image forming apparatus of the data receiver in the first storage unit as the distribution information; wherein
the control unit controls the image forming apparatus so as to distribute the stored setting information to the image forming apparatus of the data receiver which is registered by the registration unit.

3. The image forming apparatus of claim 1, further comprising:
a detection unit to detect a distribution error of the setting information to the image forming apparatus; wherein
the control unit makes the distribution information store information based on the detected distribution error when the distribution error is detected by the detection unit.

4. The image forming apparatus of claim 3, further comprising:
a counter memory to store a distribution frequency of the setting information to the image forming apparatus; wherein
the detection unit detects the distribution error based on the distribution frequency stored in the counter memory.

5. The image forming apparatus of claim 1, wherein
when the distributed setting information is insufficient in a setting item of the image forming apparatus of the data receiver, the control unit controls the image forming apparatus so as to set and distribute an initial value which is store in advance to the insufficient setting item.

6. An image forming system, comprising an image forming apparatus which comprises a server to administrate setting information regarding an image forming for each type of a recording medium, a connecting unit to connect with the server via a communication circuit, an image forming unit to carry out an image forming according to the setting information which is administered by the server, a first storage unit to store distribution information including at least information of a data receiver, an input unit to input the setting information regarding the image forming, a second storage unit to store the setting information input by the input unit, and a control unit to control so as to distribute the setting information which is stored based on the distribution information stored in the first storage unit when the setting information is stored in the second storage unit, wherein
when the setting information is stored in the second storage unit, the control unit of the image forming apparatus distributes the stored setting information to the server, and
the server comprises a third storage unit to store the setting information distributed from the image forming apparatus.

7. The image forming system of claim 6, wherein
the image forming apparatus further comprises a registration unit to register the information of the data receiver in the first storage unit as the distribution information, and
the control unit controls the image forming apparatus so as to distribute the stored setting information to the data receiver which is registered by the registration unit.

8. The image forming system of claim 6, wherein
the image forming apparatus further comprises a detection unit to detect a distribution error of the setting information to the server, and
the control unit makes the distribution information store information based on the detected distribution error when the distribution error is detected by the detection unit.

9. The image forming system of claim 8, wherein
the image forming apparatus further comprises a counter memory to store a distribution frequency of the setting information to the server, and
the detection unit detects the distribution error based on the distribution frequency stored in the counter memory.

10. The image forming system of claim 6, wherein
when the distributed setting information is insufficient in a setting item of the data receiver, the control unit controls the image forming apparatus so as to set and distribute an initial value which is stored in advance to the insufficient setting item.

11. A computer readable medium for embodying a program, wherein the program causes a computer of an image forming apparatus comprising a connecting unit to connect with other image forming apparatuses via a communication circuit and an image forming unit to carry out an image forming in compliance with setting information regarding the image forming according to types of a recording medium to realize:
storing distribution information including at least information of the image forming apparatus of a data receiver;
inputting the setting information regarding the image forming;
storing the setting information which is input; and
distributing the stored setting information to the other image forming apparatuses based on the distribution information stored when the setting information is stored.
